(19) United States
(12) Patent Application Publication
(10) Pub. No.: US 2013/0247877 A1
(43) Pub. Date: Sep. 26, 2013

(54) Free-Piston Engine for Generating Combined Heat and Power

(71) Applicant: HEATGEN LIMITED, Cramlington (GB)

(72) Inventor: David Waggott, York (GB)

(73) Assignee: Heatgen Limited, Cramlington (GB)

(21) Appl. No.: 13/845,740

(22) Filed: Mar. 18, 2013

(30) Foreign Application Priority Data
Mar. 22, 2012 (GB) 12 05 102.5
Jun. 18, 2012 (GB) 12 10-784.3

(51) Int. Cl. F02B 71/00

(52) U.S. Cl. CPC F02B 71/00
USPC 123/46 R

(57) ABSTRACT

An apparatus is provided for generation of combined heat and power comprising an engine configured in a free-piston arrangement comprising two opposed pistons arranged in an elongated cylinder having at least one inlet port and at least one outlet port with uniflow scavenging, an electricity generator, means for harnessing heat and means for transmitting load from the engine to the electricity generator. The engine is configured to operate at close to constant volume combustion, high compression ratio, a lean fuel to air ratio and uses homogeneous charge compression ignition. The engine further comprises a synchronizing mechanical or hydraulic linkage between said two opposed pistons. A method for generating combined heat and power and a method for configuring apparatus for generating combined heat and power are also provided.

### CROSS REFERENCE TO RELATED APPLICATIONS

This application claims priority from United Kingdom Patent Application No. 12 05 102.5, filed Mar. 22, 2012 and United Kingdom Patent Application No. 12 10 784.3, filed Jun. 18, 2012, the entire disclosures of which are incorporated herein by reference in their entirety.

### BACKGROUND OF THE INVENTION

1. Field of the Invention

The present invention relates to a free-piston engine, apparatus and method for generating Combined Heat and Power (CHP) with significantly higher efficiencies than those currently available. The improved efficiency derives from using a free-piston engine capable of homogeneous charge compression ignition (HCCI), very high compression ratio and lean fuel-to-air ratio as the power source.

2. Description of the Related Art

The supply, distribution and installation of boilers and air conditioners of all sizes and types are already well established in the UK. In contrast, CHP systems are not widespread in the United Kingdom (UK).

The proposed system as per the claimed invention is closest to the Baxi-DACHSTM mini-CHP system. However, the Baxi-DACHSTM mini-CHP system operates using a small single cylinder spark ignition engine with a range of fuel options, including natural gas and liquid petroleum gas. These CHP systems produce 5.5 kilowatts (kW) of electric power and between 12 and 20 kilowatts of heat energy. The Baxi-DACHSTM mini-CHP system has a claimed electrical efficiency of 24 percent (%) compared with at least 35 percent for the present invention. This means that the present invention will use 31 percent less fuel for the same electrical output.

Burning mains gas costing 2.8 pence per kilowatt hour to generate electricity using a CHP system of the prior art running at 24 percent efficiency produces electricity which costs 11.7 pence per kilowatt hour. However, it is possible to buy electricity directly from the grid system at 15 pence per kilowatt hour, so there is little benefit derived from the existing CHP systems in terms of electricity cost. In contrast, burning mains gas costing 2.8 pence per kilowatt hour to generate electricity using a CHP system running at 35 percent efficiency as in the present invention produces electricity costing 8 pence per kilowatt hour. An electrical efficiency of more than 35 percent will obviously reduce the cost even further. In addition, it will also be possible to manufacture the present invention at a lower cost than the Baxi-DACHSTM mini-CHP system. The provision of a CHP system using a free-piston engine as the power source, operating with an electrical efficiency of at least 35 percent therefore provides significant economic and environmental advantages. These electricity costs are the current tariffs charged by one UK supplier for domestic customers and very small businesses. However, the range of tariffs in the UK is narrow and further, for most tariffs, the ratio of gas to electricity prices is reasonably consistent at approximately 1 to 5.5. This means that calculations to compare the cost of the gas used to generate a kilowatt hour of electricity with the cost to buy a kilowatt hour from the grid will generally give very similar results. This is particularly true for smaller customers with typical electricity usage of around 6 kilowatts.

### BRIEF SUMMARY OF THE INVENTION

According to one aspect of the present invention, there is provided a free-piston engine for generation of combined heat and power comprising two opposed pistons arranged in an elongated cylinder having at least one inlet port and at least one outlet port with uniflow scavenging; a synchronizing linkage between the two opposed pistons; a connection from each of the two pistons to a two stage hydraulic pump and to an air-filled bounce chamber. The engine uses homogeneous charge compression ignition, very high compression ratio and a lean fuel to air ratio.

According to a second aspect of the present invention, there is provided apparatus for generation of combined heat and power comprising an engine configured in a free-piston arrangement comprising two opposed pistons arranged in an elongated cylinder having at least one inlet port and at least one outlet port with uniflow scavenging. Each of the said two pistons is connected to an air-filled bounce chamber and there lies a synchronizing linkage between said two opposed pistons. The apparatus further comprises an electricity generator; a hydraulic transmission from the engine to the electricity generator and means for harnessing heat. The engine uses homogeneous charge compression ignition, very high compression ratio and a lean fuel to air ratio.

According to a third aspect of the present invention, there is provided a method for generating combined heat and power comprising the following steps: (i) configuring a free-piston engine having two opposed pistons arranged in an elongated cylinder having at least one inlet port and at least one outlet port and uniflow scavenging; (ii) mixing fuel with air as it passes through said at least one inlet port; (iii) using said engine to convert the fuel energy into mechanical work; (iv) hydraulically transmitting the energy to an electricity generator; (v) generating electricity by means of a rotary alternator, and (vi) harnessing heat by means of an exhaust heat exchanger and from the engine and generator cooling water, wherein said engine is configured to operate at close to constant volume combustion and high compression ratio.

### BRIEF DESCRIPTION OF THE DRAWINGS

FIG. 1 shows a graph of rising electricity costs;

FIG. 2 shows a factory operating a CHP system embodied by the present invention;

FIG. 3 shows a schematic of the apparatus embodied by the present invention;

FIG. 4 shows a cross sectional diagram of a free-piston engine embodying the present invention;

FIG. 5 shows a graph displaying the close to constant volume combustion utilized by the engine of the present invention;

FIG. 6 shows a schematic of the hydraulic transmission between the engine and the electrical generator embodied by the present invention;

FIG. 7 shows an alternative embodiment of the hydraulic transmission between the engine and the electrical generator embodied by the present invention;

FIG. 8 shows a method embodying the present invention;

FIG. 9 shows a graph showing theoretical ideal Otto cycle efficiency;

FIG. 10 shows a graph displaying the two components of the bounce force;

FIG. 11 shows the hydraulic synchronization of the two opposed pistons; and

FIG. 12 shows a cross-sectional view of the hydraulic synchronizer embodying the present invention.

### DETAILED DESCRIPTION OF EXAMPLE EMBODIMENTS

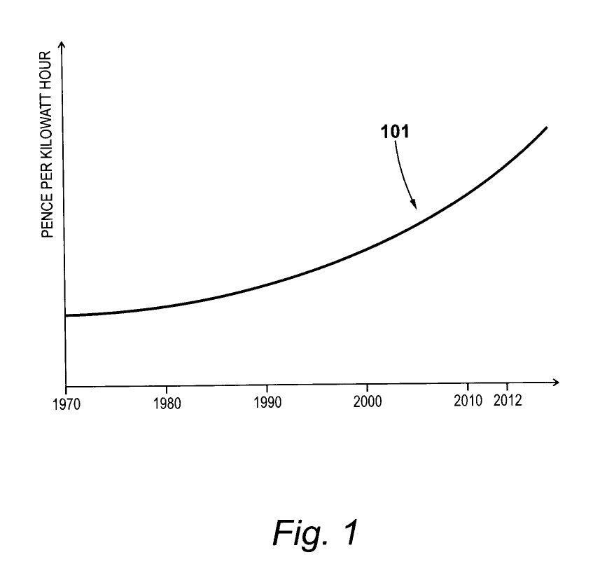

FIG. 1

Electricity costs in the United Kingdom (UK) have increased steeply in recent years, as indicated by line 101 in the graph in FIG. 1. Further, it seems certain that prices are bound to continue increasing for a number of reasons including the following. Firstly, a think tank known as the Renewable Energy Foundation has calculated that the total consumer subsidies paid out for renewable energy in the UK by 2030 will amount to £130 billion. Secondly, starting in 2017, a significant proportion of generating capacity in the UK must be retired as older coal and nuclear power stations reach the end of their economic lives. There is no practical option other than to build new power stations. These will be very expensive regardless of the type of fuel used, which may be, for example, nuclear, gas, wind or solar.

All of these enormous costs must be met by energy consumers and inevitably electricity prices will continue to increase. These high and increasing costs are a debilitating burden for industries, businesses and households of all types and sizes.

Therefore, the present proposal relates to a more efficient system for the generation of electricity which is capable of producing electricity at a lower cost than buying it from the grid system. In particular, the present proposal relates to a system for the generation of combined heat and power (CHP) using a small free-piston engine. The free-piston engine is a linear engine without a crankshaft that enables the system to have a significantly higher efficiency than those currently available. Free-piston engines have potential advantages of making more efficient use of energy, thereby using less fuel and producing lower emissions in comparison to conventional engines. These advantages are due to the constructional simplicity of free-piston engines in which output power from the engines is extracted by a load device directly coupled to the moving piston. There are also fewer energy losses through friction and use of more efficient thermodynamic cycles which contribute to the higher efficiency.

CHP gives an electricity user the ability to generate some or all of the electricity they need, using natural gas from the mains as fuel. CHP is a method that was used at the beginning of electricity generation in the United States (US). Early power stations were built in the middle of communities and heat from the power stations was used to heat houses and businesses within the community. This idea is still used in the US. The idea of CHP caught on in Northern Europe, but not to the same extent in the UK. The reason for this was probably that the UK was a cheap fuel (coal) country from the beginning of the Industrial Revolution up to the 1950s. As soon as coal began to fall out of favor in the 1950s, North Sea oil and gas was exploited and even when that started to decline, world oil prices were still relatively low. For these reasons, CHP has never as been widely used in the UK, as elsewhere.

The present CHP system can run at 80 to 90 percent or more overall efficiency when taking into account both electricity and heat output. In contrast, the most modern efficient combined cycle gas turbine power stations manage to achieve about 40 percent efficiency. Losses in transmission and distribution reduce the efficiency further. Consequently, even with the best modern power station no more than 35 percent of the fuel energy at the power station is put to useful purpose by customers.

However, with CHP a large majority of the heat energy in the fuel is captured and put to good use for space, water or process heating. Therefore, overall efficiency of the present system can be 80 to 90 percent. At times of the year when heating requirements are lower, the surplus heat can drive a heat pump to provide air conditioning.

The present invention will therefore enable energy users to reduce their total energy costs substantially and also reduce their carbon dioxide (CO₂) ‘footprint’ by an even wider margin. Depending partly on the number of hours per year the system is in operation, savings should cover the initial cost of the system in five to seven years.

For any fuel (for example, natural gas), carbon dioxide (CO₂) emissions are directly proportional to the amount of fuel used. The ratio of fuel used by a CHP system compared with electricity from the grid is the inverse of the two overall efficiencies, that is, 85 to 35. Therefore, for a given level of useful energy used, the CHP system will emit 35/85 less CO₂ than purchase of power from the grid, namely 59 percent less.

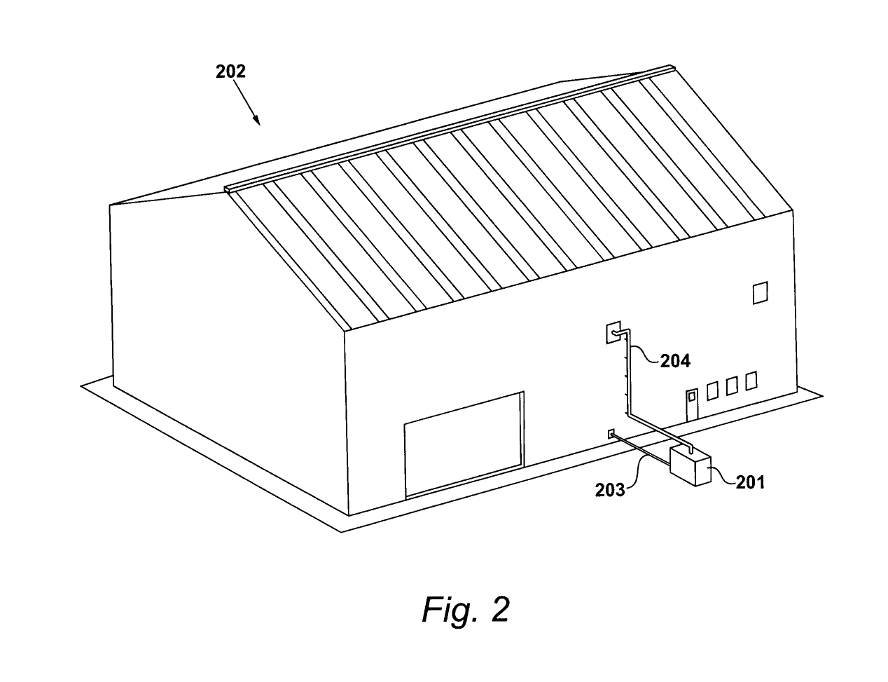

FIG. 2

The present invention relates to a small Combined Heat and Power (CHP) system 201 with a significantly higher efficiency than those currently available. The improved efficiency derives from using a free-piston engine as the power source. Higher efficiency provides a higher electrical output per unit of fuel cost which in turn creates a much more compelling economic case for prospective customers than alternative CHP systems.

The electrical output of the present proposal is 6 kilowatts and it will be possible to scale up to 12 kilowatts or more. The current proposal is therefore aimed at customers who have an electrical demand of at least 6 kilowatts and who have a useful purpose for the heat. This may be factory 202 with electrically driven machines. As shown in FIG. 2, CHP system 201 provides electricity 203 to an air conditioning unit 204, whereby surplus heat from the generation of electricity drives a reverse heat pump.

Alternatively, establishments such as old people's homes (with a steady demand for heat or air conditioning), horticultural operations, office buildings, apartment buildings, clinics, hospitals, libraries, airports, railway stations or ships may utilize the CHP system embodied in the present invention.

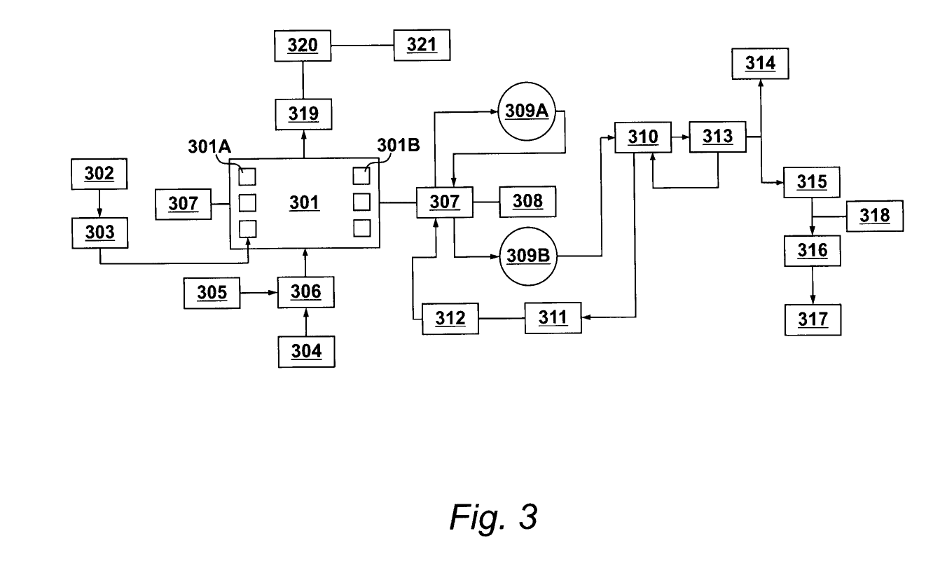

FIG. 3

A schematic of the apparatus for generation of CHP embodied by the present invention is shown in FIG. 3.

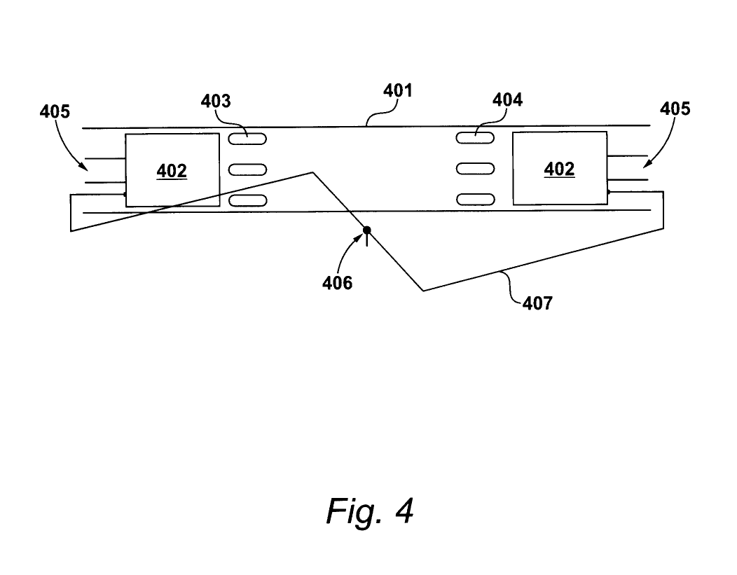

Free-piston engine 301 is essentially an internal combustion engine that runs without a crankshaft. The configuration of the presently claimed free-piston engine is an opposed piston free-piston arrangement having two single piston units in an elongated cylinder with a common combustion chamber, as further described in FIG. 4. A synchronizing linkage maintains the two opposed pistons in exact synchronization. Free-piston engine 301 in the claimed invention is more specifically a hydraulic opposed free-piston engine.

In an opposed free-piston engine, the power cycle is a two-stroke cycle wherein the piston compresses the charge, ignites it, a power stroke follows and the exhaust gases flow out of the cylinder. The combustion chamber is formed in the space between the two pistons after the compression stroke.

Each of the two pistons has a rebound device or bounce chamber 308 which acts to store the energy necessary to create the next compression stroke. The present invention uses a system of hydraulic accumulators to store energy, providing an additional bounce chamber effect, as well as an air-filled bounce chamber 308 coupled to each of the two pistons. With an air-filled bounce chamber, the pressure in the bounce chamber increases quickly towards the end of the engine working stroke (or expansion stroke) and decelerates the piston rapidly. The bounce pressure reaches a peak at the end of this working stroke, thereby reversing and accelerating the piston quickly into the compression stroke. When the exhaust ports close, the pistons are already moving relatively fast and this additional speed persists through the compression stroke. At the end of the compression stroke, the extra momentum of the piston creates a higher pressure in the combustion chamber and helps to ensure a high compression ratio and spontaneous ignition. Therefore, the use of the hydraulic accumulators to provide a bounce chamber effect and air-filled bounce chamber help to achieve the very high compression ratio required for homogeneous charge compression ignition to occur.

Each of the two pistons moves freely in the cylinder, and is connected only to a load. The load in the presently claimed invention is a hydraulic load, as further described in FIG. 4. Free-piston engine 301 embodied by the present invention is unusually simple in design with few moving parts and has a number of characteristics that allow it to reach high efficiencies which cannot be achieved by any other mechanism. According to current users, free-piston engines run “virtually continuously with very little attention or maintenance”. A further advantage is the negligible level of vibration when opposed free-piston engine 301 is in operation.

In the illustrated embodiment, free-piston engine 301 comprises a plurality of inlet ports 301A and outlet ports 301B and uses a source of natural gas 302 from the mains supply. This mains natural gas is at an extremely low pressure (less than 0.3 bar) and its pressure is raised by small gas compressor 303 to reach a pressure of approximately 1 to 2 bar, suitable for injection into the plurality of inlet ports 301A in free-piston engine 301 to mix with incoming air 304. Fuel injection can be altered to adjust the fuel to air ratio in order to achieve a lean mixture.

It is appreciated that while the embodiment shown in FIG. 3 utilizes a source of natural gas, this does not preclude alternative sources of fuel being utilized by the present invention.

In the embodiment shown, a Roots compressor 306 is used to supercharge the engine and supplies the source of incoming air 304 into one of the plurality of inlet ports 301A of free-piston engine 301. Roots compressor 306 may be driven by small hydraulic motor 305. Roots compressor 306 aids the control and speed of flow of air into the plurality of inlet ports 301A of free-piston engine 301. There must be enough pressure in the inlet manifold to begin air induction as soon as inlet port 301A opens and consequently the pressure in the inlet manifold must be high enough to overcome any residual exhaust pressure. The speed of Roots compressor 306 can therefore be altered to adjust the supercharge pressure.

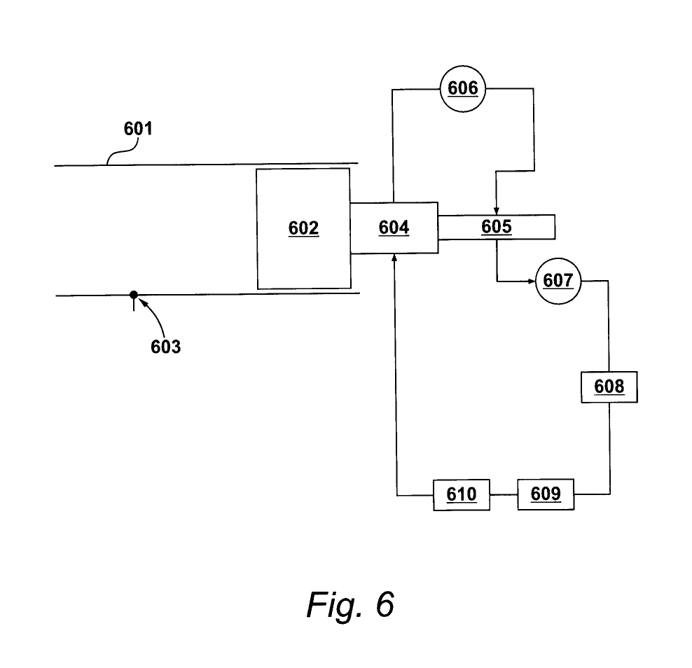

Power transmission between free-piston engine 301 and alternator 313 is by hydraulic means. A two-stage hydraulic pump 307 is coupled to each of the two opposed pistons of free-piston engine 301, as described further in relation to FIG. 6. Connected to each hydraulic pump 307 are two hydraulic accumulators, 309A and 309B. Hydraulic accumulator 309A is an intermediate pressure accumulator and hydraulic accumulator 309B is a high pressure accumulator. Hydraulic accumulators, 309A and 309B each contain both air and hydraulic fluid, separated by a diaphragm. In the embodiment illustrated in FIG. 3, hydraulic accumulators 309A and 309B are only shown in association with one of the two two-stage hydraulic pumps. However, in the claimed invention, there is clearly a two-stage hydraulic pump and hydraulic accumulators 309A and 309B coupled to each of the two opposed pistons. After passing through hydraulic accumulators 309A and 309B, the hydraulic fluid powers hydraulic motor 310 which in turn is configured to operate an electricity generator, alternator 313. In the embodiment shown in FIG. 3, alternator 313 is a rotary alternator. As indicated by the arrows linking 310 and 313, there is electronic speed control between rotary alternator 313 and hydraulic motor 310.

As shown in the illustrated embodiment, after exiting hydraulic motor 310, the hydraulic fluid passes through cooling and filtering device 311 and then into reservoir 312 before being re-used by two-stage hydraulic pump 307.

Electrical output 314 of the present invention is 6 kilowatts, although in an alternative embodiment it will be possible to scale up to 12 kilowatts. Electrical output 314 is used to operate, for example, machinery and lights.

Electrical output 314 is in the form of alternating current which although being suitable for operating plant machinery and lighting, may not be of suitable quality for feeding into the grid system as it may not display a sufficiently accurate frequency control. Therefore rectifier 315 converts this alternating current into direct current which is either stored in battery 318 or converted back into higher quality alternating current by inverter 316 before being fed into mains 317.

Exhaust heat exchanger 319 captures exhaust heat 320 from free-piston engine 301 and this heat 320, together with heat from engine and generator cooling water is used to provide, for example, hot water, space heating and process heating. In an embodiment, there is a condensing function on the end of the heat exchanger 319. Reverse heat pump 321 functions to convert heat arising from the free-piston engine and generator for cooling and air conditioning operations.

FIG. 4

The free-piston engine embodied by the present invention is shown in FIG. 4. The free-piston engine comprises a single elongated cylinder 401 and two opposed pistons 402. As is evident from FIG. 4, there is no crankshaft. The combustion chamber is formed in the space between the two pistons after the compression stroke.

There is uniflow scavenging between plurality of inlet ports 403 and plurality of outlet ports 404 and thereby fresh charge flows in one end of the cylinder and the exhaust gases flow out of the other end at the same time. Uniflow scavenging is the most sensible way to run the engine with minimal risk of losing unburnt fuel out of the exhaust. Plurality of outlet ports 404 must open before inlet ports 403 open so that exhaust gas flows out before fresh air flows into inlet ports 403.

Each opposed piston 402 is coupled to two-stage hydraulic pump 405 to enable a hydraulic means of transmitting power from the engine to the electrical generator (not shown). This hydraulic transmission is further described in FIG. 6.

In the presently claimed opposed free-piston engine, the two pistons 402 must be exactly synchronized, namely they must mirror each other and meet simultaneously at mid-point 406, the point of maximum compression or otherwise HCCI may not occur. In an embodiment of the present invention, a mechanical linkage 407 is used to achieve this synchronization. This mechanical linkage is the same as that used in early free-piston engines, such as the Pescara engine (designed and patented in the US in the 1920s) which was later adopted by the German company Junkers. Mechanical linkage 407 is advantageous in view of its simplicity.

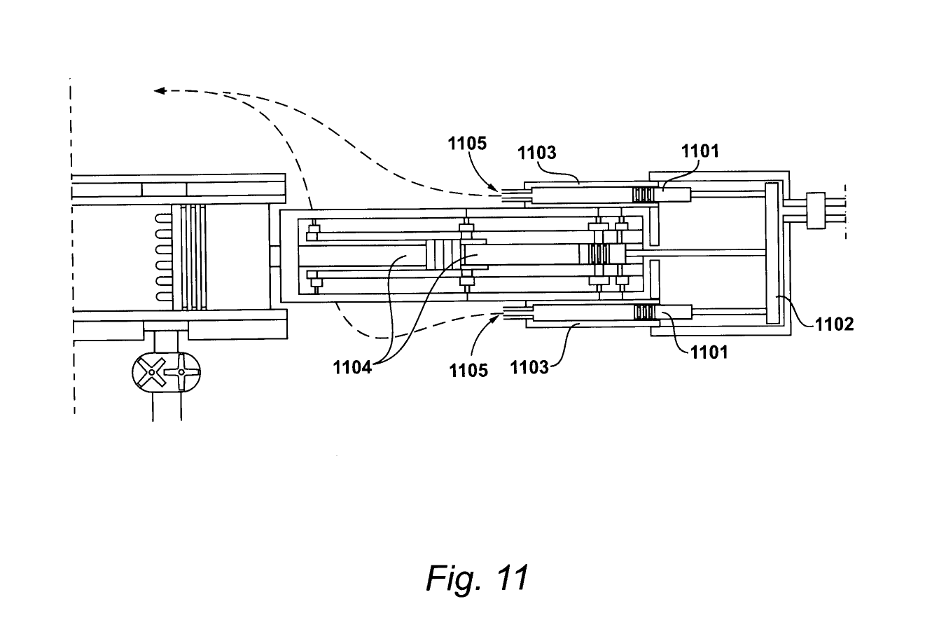

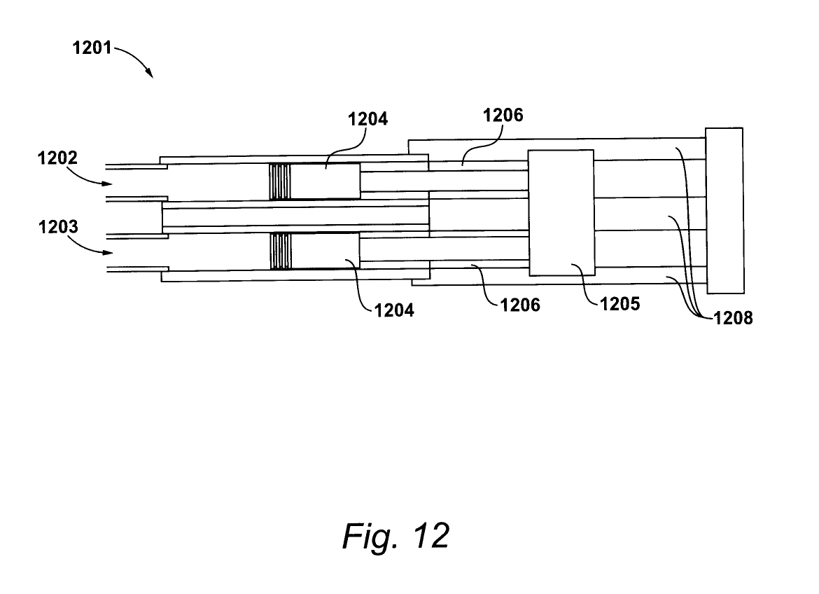

In an alternative embodiment, this synchronization of the two opposed pistons is achieved by a hydraulic system (as shown in FIGS. 11 and 12). In further alternative embodiments, synchronization mechanisms may include electronic detection of the piston position at the end of the working stroke, and controlling the pressure in the bounce chamber, that is, the pressure for the return stroke or next compression stroke. In the latter, if the pistons are not exactly synchronized, the pressure in the bounce chamber can be minutely adjusted so that by the time the next stroke occurs, the pistons are back in synchronization.

In a free-piston engine, the following five components can determine the acceleration, speed and the position of the piston movement. These components include pressure in the combustion chamber, pressure in the bounce chamber, force exerted by the load, the weight of the pistons 402 and various very small friction losses. If the piston 402 is heavier, this will slow the system down. In an embodiment, heavier pistons are used as it may be desirable to have the machine running more slowly, in order to get better conversion of fuel energy into mechanical energy.

Advantageously, the arrangement of the free-piston engine of the present invention ensures very low vibration levels.

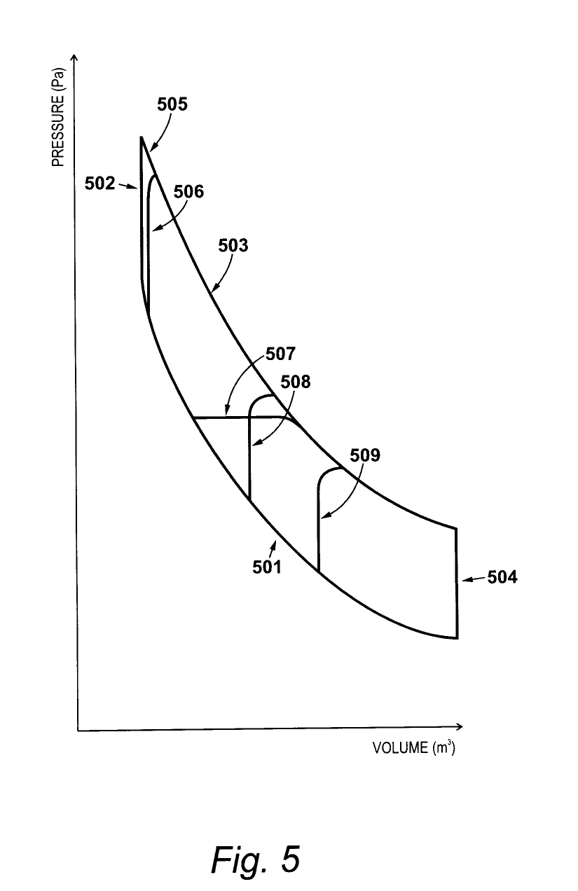

FIG. 5

FIG. 5 shows a theoretical ideal Otto Cycle (505) and emphasizes the constant volume combustion utilized by the free-piston engine of the present invention. The theoretical Otto cycle comprises adiabatic compression 501 during the compression stroke, instantaneous combustion at constant volume 502, adiabatic expansion 503 during the expansion stroke and heat rejection 504.

The characteristics of a free-piston engine with HCCI, having a compression ratio of approximately 55 to 1, are shown by line 506. The characteristics of a gas turbine at constant pressure combustion, having a compression ratio of approximately 40 to 1, are shown by line 507. The characteristics of a conventional diesel (compression ignition) engine, having a compression ratio of approximately 20 to 1, are shown by line 508. Finally, the characteristics of a conventional spark ignition engine, having a compression ratio of approximately 10 to 1, are shown by line 509.

The hydraulic opposed free-piston engine embodied by the present invention offers the potential to come close to achieving a theoretical Otto cycle with resulting high efficiency. The present invention deploys a high compression ratio of between 45 to 1 and 65 to 1 bar. The present invention also deploys heavier pistons to help increase the compression ratio by virtue of their sheer momentum.

An optimum Otto cycle also requires rapid combustion and therefore the present invention deploys homogeneous charge compression ignition (HCCI) in which the fuel/air mixture is compressed to the point of auto-ignition. During HCCI, ignition occurs at many points simultaneously throughout the combustion chamber, giving rise to extremely rapid heat release. This extremely rapid combustion means that there is no time for formation of nitrogen oxides, thereby advantageously reducing unwanted emissions. The homogeneous charge compression ignition is achieved by reaching a very high compression ratio.

Therefore, optimal conditions in the present invention comprise close to constant volume combustion, a lean fuel to air mix and a high compression ratio. To achieve and maintain this optimum cycle, it may be necessary to make adjustments to the presently claimed apparatus, such as to adjust the stroke, compression ratio, bounce chamber characteristics, supercharge pressure and fuel to air ratio. These optimal conditions of HCCI, giving close to constant volume combustion, a lean mix and a high compression ratio enable the high efficiency of the free-piston engine embodied by the present invention.

FIG. 6

The free-piston engine of the present proposal uses a hydraulic connection between the engine and the electrical generator. FIG. 6 shows a schematic of the hydraulic transmission between the free-piston engine and the electrical generator.

The free-piston engine embodied by the present invention comprises an elongated cylinder 601 having two opposed pistons 602 (only one of which is shown). Opposed pistons 602 move in synchrony to mid-point 603 of cylinder 601. The free-piston engine drives a two-stage hydraulic pump having first stage hydraulic pump 604 and second stage high pressure hydraulic pump 605 on each end of the engine. The cross sectional area of second stage high pressure hydraulic pump 605 is equal to the annulus of the first stage hydraulic pump 604, so that second stage high pressure hydraulic pump 605 can be driven through the annulus of first stage hydraulic pump 604.

On the working (expansion) stroke of the piston 602, non-compressible low pressure hydraulic fluid is pumped by first stage hydraulic pump 604 into intermediate pressure accumulator 606 as hydraulic fluid having intermediate pressure. On the compression stroke of piston 602, intermediate pressure hydraulic fluid works on second stage high pressure hydraulic pump 605 which drives first stage hydraulic pump 604 back to its original position. The same volume of hydraulic fluid that was pumped from first stage hydraulic pump 604 into intermediate pressure accumulator 606 is then pumped into a high pressure accumulator 607 by second stage high pressure hydraulic pump 605. The high pressure hydraulic fluid then drives hydraulic motor 608 which in turn drives rotary alternator 609. The present invention provides electronic speed control between the rotary alternator and hydraulic motor. After being used to drive hydraulic motor 608, the hydraulic fluid passes into reservoir 610 after being cooled and filtered.

The hydraulic system provides an element of the bounce mechanism required by the free-piston engine. On the working (expansion) stroke of piston 602, the very high combustion pressure gives piston 602 a high acceleration resulting in a high velocity. Towards the end of the expansion stroke, exhaust/outlet ports open and it is only the momentum of the piston that works against the combined load of first stage pump 604, second stage high pressure hydraulic pump 605 and the bounce chamber. Piston 602 soon stops after working against this combined load. The bounce energy stored in the bounce chamber plus the intermediate hydraulic accumulator acting on high pressure hydraulic pump 605 begin to move the piston assembly back into the compression stroke. The use of air-filled bounce chambers (as described in FIG. 3) for at least part of the bounce mechanism is preferred (the rest coming from the hydraulic bounce). A combination of air-filled bounce chambers and hydraulic bounce help to create the high compression ratio required for HCCI to occur.

In an embodiment, both 2-stage hydraulic pump 604 and 605 and hydraulic motor 608 of the present invention have high efficiencies of 97 to 98 percent and the efficiency of rotary alternator 609 is approximately 80 percent.

Therefore, a combination of 50 percent efficiency for the free-piston engine, 97 percent efficiency for the hydraulic pump, 97 percent efficiency for the hydraulic motor and 80 percent efficiency for the alternator gives an overall efficiency of about 37.5 percent efficiency. The preset proposal can therefore advantageously provide electrical efficiency of at least 35 percent. Burning mains gas costing 2.8 pence per kilowatt hour at 35 percent efficiency generates electricity at 8 pence per kilowatt hour in contrast to buying electricity from the grid costing 15 pence per kilowatt hour. The present invention therefore provides exceptional economic value. In addition, there is of course the release of heat from the engine, generator and the exhaust which can be used to do other work, for example, space heating, water heating and/or process heating. Alternatively, this waste heat can be passed through a reverse heat pump and used in air-conditioning.

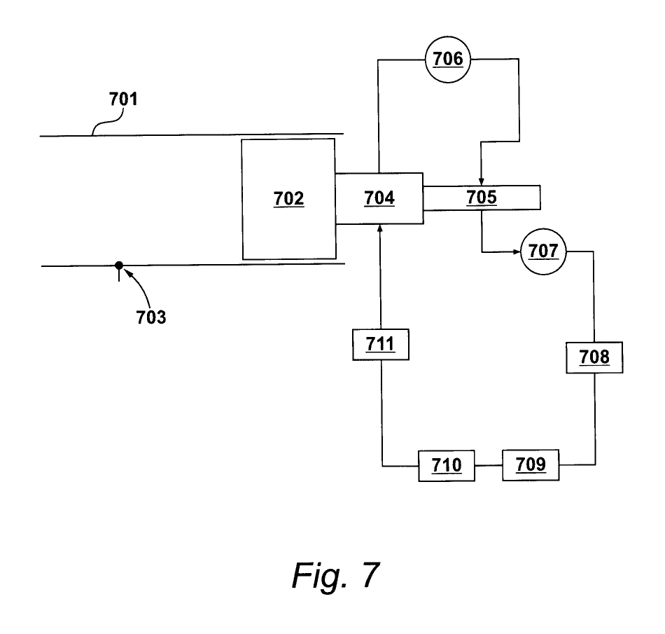

FIG. 7

In an embodiment, two stage hydraulic pump comprises a hydraulic suction valve 711 coupled to first stage hydraulic pump 704. As illustrated in FIG. 7, free-piston engine embodied by the present invention comprises an elongated cylinder 701 having two opposed pistons 702 (only one of which is shown). Opposed pistons 702 move in synchrony to mid-point 703 of cylinder 701. The free-piston engine drives a two-stage hydraulic pump having first stage hydraulic pump 704 and second stage hydraulic pump 705 on each end of the engine.

On the working stroke of the piston 702, non-compressible low pressure hydraulic fluid is pumped by first stage hydraulic pump 704 into intermediate pressure accumulator 706. On the compression stroke of piston 702, intermediate pressure hydraulic fluid works on second stage hydraulic piston 705 which drives first stage hydraulic pump 704 back to its original position. The same volume of hydraulic fluid that was pumped from first stage hydraulic pump 704 into an intermediate pressure accumulator 706 is then pumped by high pressure hydraulic pump 705 into a high pressure accumulator 707. The high pressure hydraulic fluid then drives hydraulic motor 708 which in turn drives rotary alternator 709. The present invention provides electronic speed control between the rotary alternator and hydraulic motor. After being used to drive hydraulic motor 708, the hydraulic fluid passes into reservoir 710 after being cooled and filtered.

As illustrated in FIG. 7, suction valve 711 opens and closes to let hydraulic fluid into first stage hydraulic pump 704. Suction valve 711 is the first valve that the hydraulic fluid passes through after leaving reservoir 710. It is a known problem of the prior art that the delayed opening and closing of suction valve 711 leads to a response lag between hydraulic pump pressure and piston displacement at the start of the expansion/working stroke. It is therefore desirable to overcome this delayed opening and closing of suction valve 711 and the presently claimed invention provides three mechanisms to achieve this.

Firstly, pressure in reservoir 710 may be increased using an air compressor. This would decrease the output of hydraulic motor 708 that drives alternator 709.

Secondly, an electronic assist, a hydraulic assist, an electro-hydraulic assist or a pneumatic assist may be used to aid the opening and closing of suction valve 711. Such assistance enables valve 711 to fully open to a wide position so that low pressure hydraulic fluid from reservoir 710 can flow easily and without hindrance into the first stage hydraulic pump 704 the instant that the piston of first stage hydraulic pump 704 starts moving. The assistance ensures that the hydraulic fluid is not impeded in its path by a valve which is not fully wide open and means that valve 711 is opened by assistance, rather than allowing suction to open it. Subsequently, valve 711 is assisted on its closure just before the hydraulic compression stroke begins.

With regard to the pneumatic assist, when the pistons 702 stop and reverse direction at the end of the engine working (expansion) stroke, the pressure in the air bounce chamber reaches a peak. The present proposal uses the bounce air pressure, acting on a small pneumatic piston, to promptly open suction valve 711 at the instant the hydraulic piston stops and the hydraulic pressure falls to zero. This allows fluid to flow into the low pressure pump cylinder as soon as the piston begins to move on the suction stroke. At the other end of the stroke, a light spring helps suction valve 711 to close as soon as the fluid stops flowing into the cylinder, thereby allowing the piston to promptly increase the pressure and drive fluid into the accumulator. The pneumatic assist and spring closure of hydraulic suction valve 711 therefore considerably reduces the above outlined response lag problems of suction valve 711.

Thirdly, a modest compression stroke is performed on low pressure hydraulic fluid exiting reservoir 710 (for example, pressure of the hydraulic fluid may be raised from 1 bar to 5 bar) by an auxiliary hydraulic pump activated off the synchronizing linkage. This means that when the low pressure hydraulic fluid exiting reservoir 710 hits the suction valve 711, it already has some pressure and is thereby pushed into the cylinder of first stage hydraulic pump 704 rather than being sucked in.

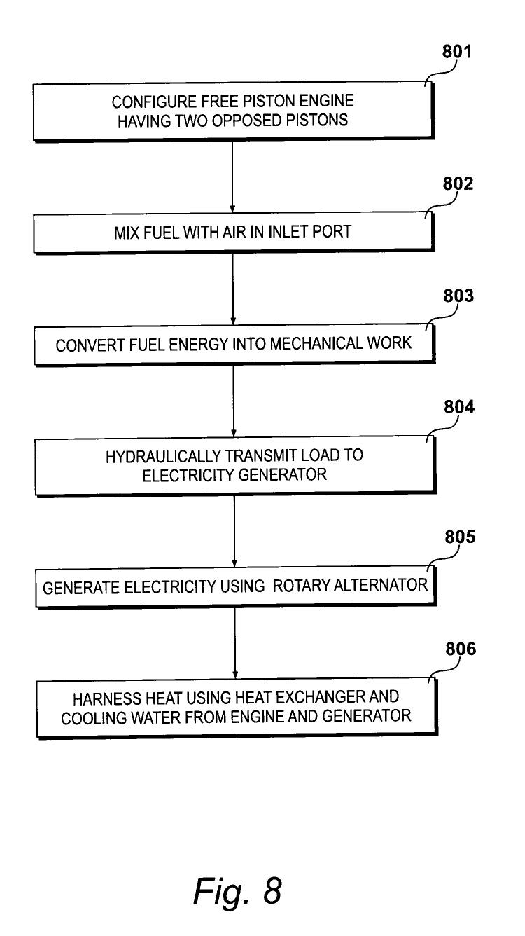

FIG. 8

As shown in FIG. 7, the present invention also relates to a method for generating combined heat and power comprising a number of steps.

A free-piston engine is configured at step 801 having two opposed pistons arranged in an elongated cylinder with at least one inlet port and at least one outlet port and uniflow scavenging. Thereby fresh charge flows in one end of the cylinder and the exhaust gases flow out of the other end at the same time. Uniflow scavenging is the most sensible way to run the engine with minimal risk of losing unburnt fuel out of the exhaust. The engine is configured to operate at close to constant volume combustion, high compression ratio and a lean fuel to air ratio.

Each opposed piston is coupled to two-stage hydraulic pump 405 to enable a hydraulic means of transmitting the power from the engine to the electrical generator (not shown). This hydraulic transmission is further described in FIG. 6.

In the presently-claimed opposed free-piston engine, the two pistons must be exactly synchronized, namely they must mirror each other and meet simultaneously at the point of highest compression or otherwise HCCI may not occur. In an embodiment of the present invention, a mechanical linkage is used to achieve this synchronization. This mechanical linkage is the same as that used in early free-piston engines, such as the Pescara engine (designed and patented in the US in the 1920s). Mechanical linkage is advantageous in view of its simplicity.

In an alternative embodiment, this synchronization of the two opposed pistons is achieved by a hydraulic system (shown in FIGS. 11 and 12). In further alternative embodiments, synchronization mechanisms may include electronic detection of the piston position at the end of the working stroke, and controlling the pressure in the bounce chamber, that is, the pressure for the return stroke or next compression stroke. In the latter, if the pistons are not exactly synchronized, the pressure in the bounce chamber can be minutely adjusted so that by the time the next stroke occurs, the pistons are back in synchronization.

Fuel is mixed with air as it flows through the inlet ports at step 802. The free-piston engine embodied by the present invention uses a source of natural gas from the mains supply. This mains natural gas is at an extremely low pressure (less than 0.3 bar) and its pressure is raised by a small gas compressor to reach a pressure of approximately 1 to 2 bar, suitable for injection into inlet ports in the free-piston engine to mix with incoming air. Fuel injection can be altered to adjust the fuel to air ratio in order to achieve a lean mixture.

It is appreciated that whilst an illustrated embodiment utilizes a source of natural gas, this does not preclude alternative sources of fuel being utilized by the present invention.

At step 803, the free-piston engine is used to convert the fuel energy into mechanical work. Each of the two pistons in the free-piston engine moves freely in the cylinder, and is connected only to a load. The load in the presently claimed invention is a hydraulic load, as further described in FIG. 4.

At step 804 the load is hydraulically transmitted to an electricity generator. Transmission of power between the free-piston engine and the alternator is by hydraulic means. A two-stage hydraulic pump is coupled to each of the two opposed pistons of free-piston engine, as described further in relation to FIG. 6. Connected to each hydraulic pump are two hydraulic accumulators. Hydraulic accumulator 606 is an intermediate pressure accumulator and hydraulic accumulator 607 is a high pressure accumulator. Hydraulic accumulators each contain both air and hydraulic fluid, separated by a diaphragm. In the embodiment illustrated in FIG. 3, hydraulic accumulators are only shown in association with one of the two two-stage hydraulic pumps. However, in the claimed invention, there is clearly a two-stage hydraulic pump and hydraulic accumulators coupled to each of the two opposed pistons.

After passing through hydraulic accumulators, the hydraulic fluid powers a hydraulic motor which in turn is configured to operate an electricity generator. In an embodiment the electricity generator is a rotary alternator. Thereby, at step 805, electricity is generated by means of a rotary alternator.

At step 806, heat is harnessed by means of an exhaust heat exchanger and from the cooling water of the engine and the generator. This heat is used to provide, for example, hot water, space heating and process heating. In an embodiment, there is a condensing function on the end of the heat exchanger. A reverse heat pump functions to convert heat arising from the exhaust heat exchanger, engine and generator for cooling and air conditioning operations.

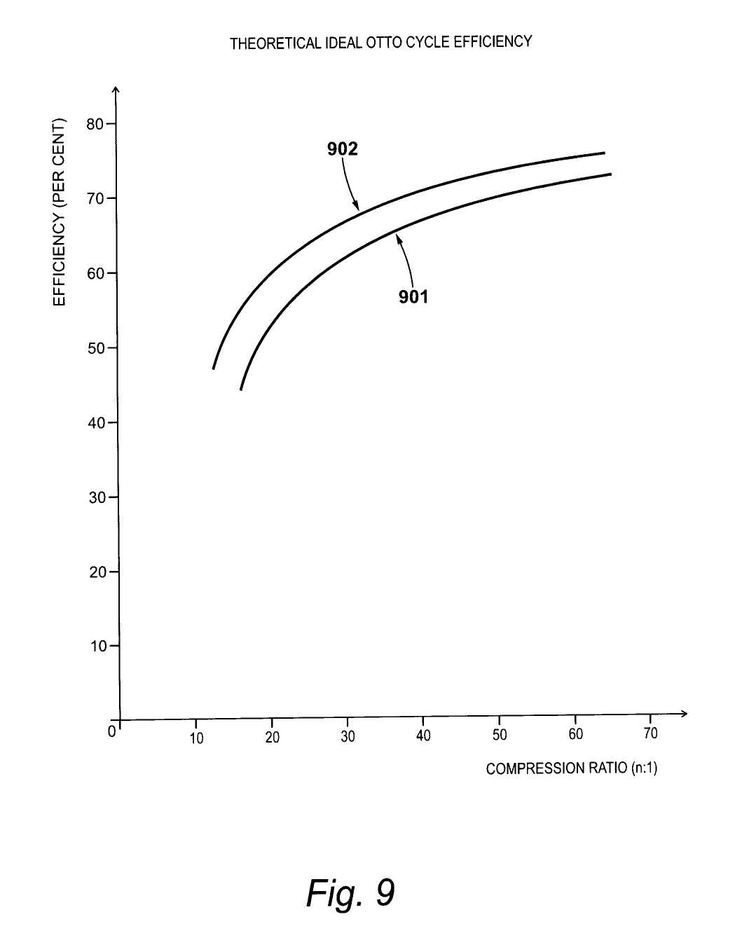

FIG. 9

The efficiency of the Otto cycle varies with compression ratio and a higher compression ratio leads to higher efficiency. As indicated in FIG. 9, the efficiency of the Otto cycle also varies with fuel to air ratios and a leaner (that is, more air than in a stoichiometric mixture) fuel to air ratio leads to higher efficiency. Line 901 compares how the efficiency varies with compression ratio for a stoichiometric fuel to air ratio (1.0) 901 versus a lean fuel to air ratio (0.4) 902. The present invention therefore deploys a lean mixture, enabling the theoretical Otto cycle efficiency to be higher.

A problem with lean mixes is that the leaner they are the harder they are to ignite. However, the high compression ratio deployed by the present invention ensures that HCCI occurs even with a lean fuel to air ratio. Use of a lean mixture allows combustion to be virtually complete so that there is practically no possibility for the formation of unwanted carbon monoxide or particulate carbon emissions.

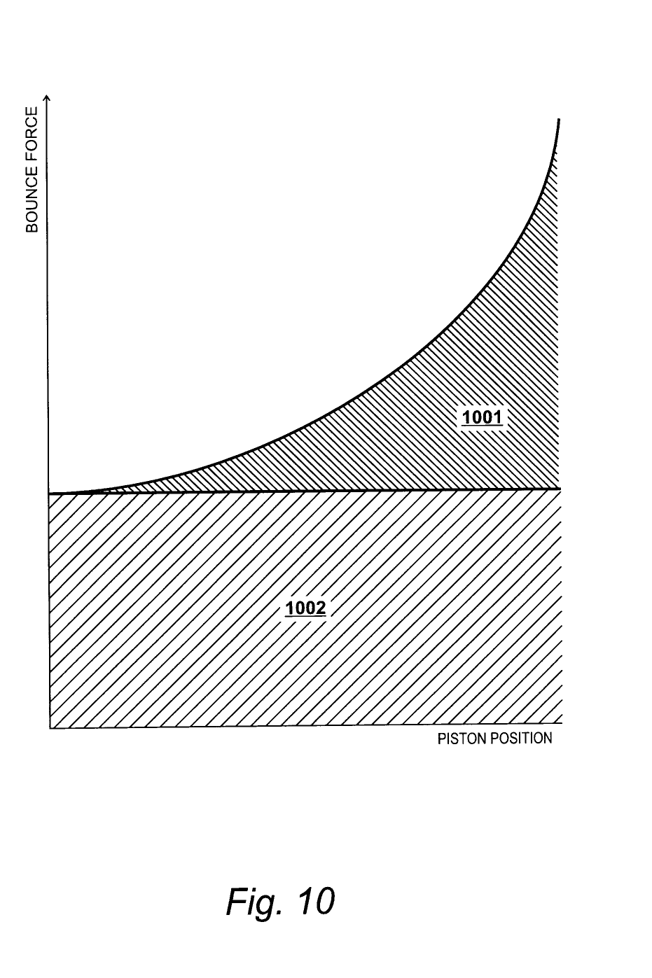

FIG. 10

As shown in FIG. 10, an air-filled bounce chamber 1001 provides at least part of the bounce force, the rest coming from the hydraulic bounce 1002. A combination of air-filled bounce chambers and hydraulic bounce helps to create the high compression ratio required for HCCI to occur.

FIG. 11

FIG. 11 shows synchronization of the two opposed pistons using a hydraulic system. At each end of the presently claimed free-piston engine, two hydraulic pistons 1101 are driven from the reverse side of the bounce chamber piston 1102. Each hydraulic piston 1101 slides in a hydraulic cylinder 1103 mounted on the outside casing of the main high pressure hydraulic pump 1104. Outlets 1105 from hydraulic cylinders 1103 join together and are then connected (shown by dashed line) to one side of the hydraulic synchronizer (shown in FIG. 12). Similarly, the small hydraulic cylinders 1103 at the other end (not shown) of the free-piston engine are connected to the other side of the hydraulic synchronizer.

FIG. 12

Hydraulic synchronizer 1201 is shown in FIG. 12. Hydraulic synchronizer is connected to the left hand side of the free-piston engine at point 1202 and to the right hand side of the free-piston engine at point 1203. Two pistons 1204 are solidly connected together by crosshead 1205 via their respective piston rods 1206. This assembly of pistons 1204 and crosshead 1205 slides freely in the cylinders and between guides 1208.

When the free-piston engine is running normally and in synchrony, there is virtually zero pressure in the synchronizer system. However, if the main piston assembly on one side of the engine tends to move slightly ahead of the piston assembly on the other side, the pressure in the “advanced” side of the synchronizer will be increased and the pressure on the other side will be reduced (since the two pistons of the synchronizer are joined solidly together). If the two sides of the free piston engine move further out of synchrony, the difference in pressure between the two sides of the synchronizer will increase.

The increased pressure in one side of the synchronizer will press on the corresponding bounce piston and attempt to retard it, while the reduced pressure on the bounce piston on the other side of the engine will attempt to advance that side of the free-piston engine. Although the difference in pressures will be very small compared with the forces acting in the engine as it is running, they will be persistent and will continue (for hundreds or even thousands of cycles if necessary) and will eventually bring the free-piston engine back into perfect synchrony.

What we claim is:

1. A free-piston engine for generation of combined heat and power comprising:
two opposed pistons arranged in an elongated cylinder having at least one inlet port and at least one outlet port with uniflow scavenging;
a synchronizing linkage between the two opposed pistons;
a connection from each of the two pistons to a two stage hydraulic pump and to an air-filled bounce chamber; and wherein
said engine uses homogeneous charge compression ignition, very high compression ratio and lean fuel to air ratio.

2. The engine as claimed in claim 1, wherein said synchronizing linkage is a mechanical linkage.

3. The engine as claimed in claim 1, wherein said synchronizing linkage is a hydraulic linkage.

4. The engine as claimed in claim 1, wherein said two stage hydraulic pump further comprises a hydraulic suction valve having electronic, pneumatic or hydraulic assistance for opening and closing.

5. Apparatus for generation of combined heat and power comprising:
an engine configured in a free-piston arrangement comprising two opposed pistons arranged in an elongated cylinder having at least one inlet port and at least one outlet port with uniflow scavenging, wherein each of said two pistons is connected to an air-filled bounce chamber;
a synchronizing linkage between said two opposed pistons;
an electricity generator;
a hydraulic transmission from the engine to the electricity generator; and
means for harnessing heat; wherein
said engine uses homogeneous charge compression ignition, very high compression ratio and lean fuel to air ratio.

6. The apparatus as claimed in claim 5, wherein said synchronizing linkage is a mechanical linkage.

7. The apparatus as claimed in claim 5, wherein said synchronizing linkage is a hydraulic linkage.

8. The apparatus as claimed in claim 5, wherein said electricity generator is a rotary alternator.

9. The apparatus as claimed in claim 5, wherein said hydraulic transmission comprises a two stage hydraulic pump connected to each piston.

10. The apparatus as claimed in claim 9, wherein said two stage hydraulic pump further comprises a hydraulic suction valve having an electronic, pneumatic or hydraulic assistance for opening and closing.

11. The apparatus as claimed in claim 10, wherein said hydraulic transmission comprises at least one intermediate pressure hydraulic accumulator and at least one high pressure hydraulic accumulator.

12. The apparatus as claimed in claim 5, wherein said means for harnessing heat is a heat exhaust gas exchanger.

13. The apparatus as claimed in claim 12, wherein said heat exhaust gas exchanger further comprises a condenser.

14. The apparatus as claimed in claim 5, wherein air is mixed with fuel at said at least one inlet port as it flows through said at least one inlet port.

15. The apparatus as claimed in claim 14, wherein said fuel is mains natural gas.

16. The apparatus as claimed in claim 15, wherein said gas is compressed prior to mixing with air.

17. The apparatus as claimed in claim 16, wherein said air is compressed by a Roots compressor prior to mixing with fuel.

18. A method for generating combined heat and power comprising the following steps:
(i) configuring a free-piston engine having two opposed pistons arranged in an elongated cylinder having at least one inlet port and at least one outlet port and uniflow scavenging;
(ii) mixing fuel with air as it flows through said at least one inlet port;
(iii) using said engine to convert the fuel energy into mechanical work;
(iv) hydraulically transmitting the energy to an electricity generator;
(v) generating electricity by means of a rotary alternator;
(vi) harnessing heat by means of an exhaust heat exchanger and engine and generator cooling, wherein said engine is configured to operate at close to constant volume combustion, high compression ratio and lean fuel to air ratio.

19. The method as claimed in claim 18, wherein said free-piston engine uses homogeneous charge compression ignition.

20. The method as claimed in claim 18, wherein said free-piston engine further comprises two air-filled bounce chambers.

21. The method as claimed in claim 18, wherein said engine further comprises a synchronizing mechanical linkage between said two opposed pistons.

22. The method as claimed in claim 18, wherein said engine further comprises a synchronizing hydraulic linkage between said two opposed pistons.
